(19) United States
(12) Patent Application Publication
(10) Pub. No.: US 2012/0288727 A1
(43) Pub. Date: Nov. 15, 2012

(54) Foamed carbon space craft

(76) Inventor: William Snyder Karn, Bellevue, PA (US)

(21) Appl. No.: 13/068,313

(22) Filed: May 9, 2011

(51) Int. Cl. B32B 27/00; C08L 33/20; C08K 3/34; C08J 9/06; C08J 9/35

(52) U.S. Cl. 428/500; 521/89; 521/86

(57) ABSTRACT

Subject is rocket foam. This letters patent is for construction of a space craft from acrylonitrile foam polymer. The new art involves making a polymer sheet plasticized with sulfur dioxide gas. The plasticize sheet is drape formed and then heated to drive off the gas leaving a rigid foamed polymer shape. The sheet during plasticize step is given a thin adherent layer of sand mingled in acrylonitrile polymer powder. Thermal heating during rocket reentry orbit generates a skin layer of carbide. The carbide protects against flame temperature air, to prevent combustion of the underlying carbon foam structure. A variation is to make the acrylonitrile polymer as a latex paint and apply such paint to a screen form geometry.

### BRIEF SUMMARY OF THE INVENTION

This invention began with discovery of use of sulfur dioxide to produce foam polyacrylonitrile. Exposure of a layer of powder polyacrylonitrile to sulfur dioxide gas forms a coherent sheet layer. Heat drives off the gas leaving behind a foamed polymer. Very high temperature heating with protection from oxygen converts the organic polymer to carbon element to produce a very strong foamed carbon of low bulk density structure. Protection from oxygen ignition can be achieved with a coating of sand which with the foam carbon structure forms silicon carbide.

### BRIEF DESCRIPTION OF THE SEVERAL VIEWS OF THE DRAWING

FIG. 1 is a cross section view of a table top upon which has been sprinkled a layer of polyacrylonitrile powder, the assembly having a plenum to receive sulfur dioxide gas and to contact the powder with the gas.

FIG. 2 shows a polymer sheet draped over a screen structure shaped like an airfoil.

### BACKGROUND OF THE INVENTION

Prior art for thermal protection of rocket craft during high speed reentry into the atmosphere uses heat shield tiles. Such tiles sometimes fall loose. Such tile adds a weight penalty. Such tile adds nothing in the nature of craft structure support. The present invention of itself is a self supporting structure with high strength to weight ratio and is not brittle or capable of brittle fracture failure. A layer of polyacrylonitrile powder admixed with sand is provided for the rocket surface,

### OBJECT OF INVENTION

It is therefore one object of the present invention to exploit a new material for rocket craft construction. Another object is to choose a design that is easy to manufacture, easy to maintain, and achieves economy in usage. Another object is to create a carbon foam that has oriented film cell walls rivaling carbon fiber in strength.

### DETAILED DESCRIPTION OF THE DRAWINGS

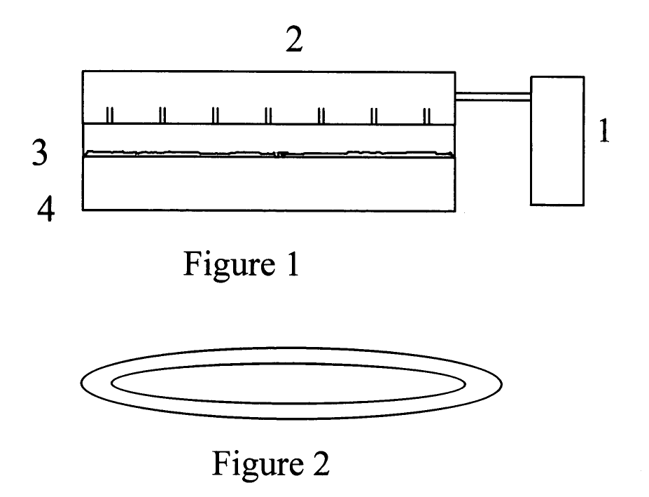

FIG. 1 serves to show the equipment functional components in relation to one another. Part 1 is a cylinder supply source of sulfur dioxide gas. Part 2 is a panel distribution manifold plenum for passing sulfur dioxide gas to mix with a layer of acrylonitrile powder (part 3) lying on table top part 4. The part 2 is a removable cover resting on part 4.

The gas enters a manifold chamber which has a multitude of outlet holes. The outlet provision may be simply a fine mesh screen. The object is to have the gas to flow gently when first contacting the powder.

FIG. 2 shows an airfoil formed of foamed acrylonitrile polymer.

The original foam discovery work was with the commercial acrylonitrile fabric of trade name called Creslan. Subsequently an equivalent polyacrylonitrile product was made in an aqueous polymerization system. The polymer was produced in the form of a fine powder when filtered free of water and dried. The surprise is that sulfur dioxide gas contact with the powder effects a fusion together of the powder particles just as readily as use of liquid sulfur dioxide does the fusion job. The resulting dough consistency material can be rolled into a sheet like pastry pie dough.

FIG. 2 shows a polymer pastry sheet draped over a screen structure shaped like an airfoil. Heating is applied to cause foaming as the sulfur dioxide gas is driven off. Just as an airfoil shape is formed, so just any surface of the rocket space craft can be formed.

Acrylonitrile polymer plasticized with sulfur dioxide is easy material to work with. A pair of scissors was used to cut free a small sample of polymer. There was no residue sticking to the cutting tool.

We do want sticking, adhesion, between the foamed sheet and the support screen. Adhesion is readily achieved by first painting the screen with latex paint. Such paint is sold at hardware stores. The paint is a copolymer, predominately of acrylonitrile. Thus the sulfur dioxide gas can plasticize both surfaces to be joined.

The external shell of a rocket space craft is to be of foamed polyacrylonitrile. The rocket has surface regions that are raised to a red heat by air friction and air compression. Heat promotes reaction between sand and acrylonitrile forming a protective skin of silicon carbide.

The following description is a narrative of the manufacturing process.

We covered a flat surface with an ample layer of polyacrylonitrile powder, added a cover, and slowly passed in sulfur dioxide gas. Notice a detail of gas inlet flow in FIG. 1. There are multiple gas inlet pores in the cover over the full reaction chamber area. The cover has an equally wide area manifold matching the reaction chamber area to serve the multitude of pores from a single hose supply. The concept of multiple gas inlet pores is illustrated in FIG. 1 as stubby paired lines in a row. The actual equipment construction would be a tight woven screen. The gas entry function is not to blow away polymer powder before the polymer has a chance to become plasticized and consolidated into a sheet.

The next maneuver is to drape form the polymer sheet to nest against the polymer painted screen. The gas plasticized sheet is easily pushed into place, adhering to the polymer layer that was painted on to the screen. Heating to drive off the sulfur dioxide gas is the final step. That leaves a strong, firm foamed polymer structure. Such structure is the shell of a rocket space craft.

When the space craft returns to enter the earth's atmosphere the high speed impact with air raises the temperature of the rocket shell structure. The sand reacts with the polymer carbon to create a protective layer of silicon carbide. The sand, when originally added to the not yet plasticized polymer powder, was silicon dioxide sand crushed to a powder.

The above narrated process offers an inspiring vision. We need not wait to add powdered sand to polymerized acrylonitrile. Put the powdered silicon dioxide (sand) in the aqueous latex polymerization mix. We make a latex paint that does the job. The airfoil of FIG. 2 has a screen defining core geometry and the acrylonitrile polymer is applied with a paint brush. Successive layers may be applied alternated with exposure to sulfur dioxide gas and foaming by heating. It is anticipated that the sand powder particles trapped in the acrylonitrile polymer will promote a finer dimension of foam bubbles when heat drives off the sulfur dioxide gas.

I claim:

1. A rocket space craft clad with acrylonitrile polymer which polymer has been plasticized and foamed with sulfur dioxide.

2. Sheet formed acrylonitrile polymer, said polymer being plasticized with sulfur dioxide, said sheet being draped over a mesh screen to which screen gripping is achieved with a coating of latex paint on the mesh screen.

3. Sheet form of acrylonitrile polymer which polymer has been plasticized and foamed with sulfur dioxide wherein the sheet is processed from a latex paint formed by polymerization of acrylonitrile.

4. The sheet form of claim 3 wherein said latex paint contains powdered silicon dioxide.
